(19) United States
(12) Patent Application Publication
(10) Pub. No.: US 2009/0144516 A1
(43) Pub. Date: Jun. 4, 2009

(54) SYSTEMS AND METHODS FOR MANAGING DATA STORAGE MEDIA

(76) Inventor: Miklos Sandorfi, Northborough, MA (US)

Correspondence Address: LOWRIE, LANDO & ANASTASI, LLP, ONE MAIN STREET, SUITE 1100, CAMBRIDGE, MA, 02142, US

(21) Appl. No.: 12/277,167

(22) Filed: Nov. 24, 2008

Related U.S. Application Data
(60) Provisional application No. 60/992,199, filed on Dec. 4, 2007.

(51) Int. Cl. G06F 12/00

(52) U.S. Cl. 711/163; 711/E12.001

(57) ABSTRACT

Systems and methods are provided for passive data migration. A method is presented for distributing data that includes acts of identifying a date by which a computer readable medium is to be decommissioned and restricting distribution of data to the computer readable medium to reach a state of data content suitable for decommissioning the computer readable medium by the identified date. A system implementing data migration includes a storage medium, an interface and a processor. The interface is adapted to receive information to be stored on a storage medium, and the processor is configured to restrict storage of the data on one storage medium based on a target decommission date for that storage medium.

### RELATED APPLICATIONS

This application claims priority under 35 U.S.C. §119(e) to U.S. Provisional Application Ser. No. 60/992,199, entitled “SYSTEMS AND METHODS FOR MANAGING DATA STORAGE MEDIA,” filed on Dec. 4, 2007, which is herein incorporated by reference in its entirety.

### BACKGROUND OF INVENTION

1. Field of Invention

Aspects of the present invention relate to data storage and, more particularly, to apparatus and methods for utilizing storage media based on the characteristics of the storage media and the data stored therein.

2. Discussion of Related Art

Various tools exist for moving computer readable data from one storage location to another. Where the amount of data stored in computer readable form is relatively small, simple operating system commands, such as copy and back-up commands, may meet the data movement needs of most computer users. However, as the amount and/or criticality of data stored in computer readable form increases, the need for a sophisticated data migration system arises. At least two distinct approaches to migrating data are manifest in data migration tools. More specifically, data migration tools may be classified as “online” or “offline,” depending on their impact to the availability of the media and data upon which they act.

Online migration tools typically allow other entities, for example, processing threads, software applications, users, etc., to access the data upon which the migration tool is operating while that data is being migrated. Conventional online migration tools may be viewed as completing data migration in two distinct steps. In a first step, the online migration tool copies data from a primary storage location on one storage medium to a secondary storage location on another storage medium using, for example, excess system bandwidth. In the second step, the online migration tool redundantly writes changes in the data stored in the primary location to the data stored in the secondary location. This redundant writing of changed data to multiple locations is often referred to in the relevant art as “data mirroring.” By using data mirroring, online migration tools enable other entities to change data stored in the primary location while the online migration tool is in operation. Thus, the primary data, and its associated media, remain online during the data migration.

Offline migration tools, on the other hand, typically do not allow other entities to access data subject to their migration activities. Conventional offline migration tools require that the storage medium, and/or the data itself, be isolated from access by other entities until a complete copy of the data is made on another storage medium. Once this copy is complete, either storage medium may be placed online for access by other entities.

### SUMMARY OF INVENTION

Aspects and embodiments of the present invention provide for a system that overcomes or alleviates at least some of the problems associated with conventional data migration tools. For example, one embodiment allows for online migration of data without the additional consumption of system resources that characterizes conventional online data migration tools.

In broad overview, aspects and embodiments are directed to a data storage system that manages the storage location of data based on the characteristics of the storage media and the data being stored. More particularly, the data storage system may use software and hardware to determine the useful life remaining for each storage medium included in the managed storage media. The data storage system may house the managed storage media, or the managed storage media may be housed elsewhere. The data storage system may be configured for use in a variety of capacities including as a backup storage system. The storage system may store data within the managed storage media such that each storage medium may be retired by the end of its remaining useful life, without the need for additional data migration. In addition, applications implemented in hardware and/or software are provided for configuring storage media policies that help define how the data storage system should manage the distribution of data within any available storage media.

One aspect is directed a method for distributing data on a plurality of computer readable data storage media. The method includes identifying a decommission date of a first data storage medium of the plurality of computer readable data storage media, and configuring a controller to restrict storage of the data on the first data storage medium as of a restriction date that is prior to the decommission date. In the method, identifying the decommission date may include identifying the decommission date based at least in part on a commissioning date of the first data storage medium. In the method, configuring the controller to restrict storage may include configuring the controller to cease allocation of unused storage capacity on the first data storage medium. In the method, configuring the controller to restrict storage may include configuring the controller to prohibit storage of the data on the first data storage medium. In the method, configuring the controller to restrict storage may include configuring the controller to redirect the data from the first data storage medium to a second data storage medium of the plurality of computer readable data storage media.

The method may further include defining the restriction date based at least in part on the decommission date. The method may further include adjusting the decommission date based at least in part on past utilization of the first data storage medium. The method may further include comprising adjusting the decommission date based at least in part on anomalous operation of the first data storage medium. The method may further include copying stored data from the first data storage medium to a second data storage medium of the plurality of computer readable data storage media. The method may further include defining a targeted state of data content for the first data storage medium to be reached by the decommission date, and wherein determining the restriction date includes determining the restriction date based at least in part on the decommission date and the targeted state of data content. In the method, defining the targeted state of data content may include defining the targeted state of data content based at least in part on metadata describing the data associated with the first data storage medium. In the method, defining the targeted state of data content based at least in part on metadata may include defining the targeted state of data content based at least in part on an expected lifespan of the data associated with the first data storage medium. In the method, defining the targeted state of data content based at least in part on metadata may include defining the targeted state of data content based at least in part on an association of a software application with the data associated with the first data storage medium.

The method may further include notifying a user that the first data storage medium is ready to be decommissioned. In the method, notifying the user may include transmitting an electronic notification. In the method, notifying the user may include illuminating a beacon.

Another aspect is directed toward a computer readable medium including computer readable instructions that, as a result of being executed by a processor, instruct the processor to perform a method including identifying a decommission date of a first data storage medium of the plurality of computer readable data storage media, and configuring a controller to restrict storage of the data on the first data storage medium as of a restriction date that is prior to the decommission date.

Another aspect is directed toward a system for storing data including a first storage medium, an interface configured to receive data to be stored and a controller coupled to the first storage medium and to the interface and configured to restrict storage of the data on the first data storage medium based at least in part on a decommission date for the first data storage medium. The system may further include a second storage medium and the processor may be further configured to store the data on the second storage medium. The system may further include a physical notification device coupled to the first data storage medium, the physical notification device indicating when the first data storage medium is ready to be decommissioned. In the system the processor may be further configured to adjust the decommission date based at least in part on utilization data associated with the first storage medium.

Another aspect is directed toward a method of storing data in a system including multiple data storage devices. The method may include storing data on the multiple data storage devices and identifying a decommission date on which a first data storage device is to be decommissioned. In the method, storing the data may include distributing the data across any of the multiple data storage devices other than the first data storage device as of a restriction date that is prior to the decommission date.

Another aspect is directed toward a method of storing data in a backup data storage system that includes a plurality of data storage devices. The method may include reading metadata describing the plurality of data storage devices, the metadata indicating a decommission date of a first data storage device of the plurality of data storage devices and restricting storage of the data on the first data storage device of the plurality of data storage devices based at least in part on the metadata. In the method, restricting storage may include restricting storage of the data on the first data storage device of the plurality of data storage devices based at least in part on a predetermined attribute of the first data storage device of the plurality of data storage devices. In the method, restricting storage of the data on the first data storage device of the plurality of data storage devices based at least in part on the predetermined attribute may include restricting storage of the data on the first data storage device of the plurality of data storage devices based at least in part on a decommission date being within a predetermined proximity to the current date.

The method may further include defining a restriction date based at least in part on the metadata. In the method, restricting storage may include restricting storage of the data on the first data storage device of the plurality of data storage devices based at least in part on the restriction date.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of one example of a networked computing environment that includes a data storage system;

FIG. 2 is a block diagram representing several hardware and software components of a data storage system according to aspects of the invention;

FIG. 3 is a visual representation of one example of a logical unit structure according to aspects of the invention;

FIG. 4 is a flow chart of a process for managing data storage according to aspects of the present invention;

FIG. 5 is a block diagram depicting a user interacting with a software element in accordance with aspects of the present invention; and

FIG. 6 is a block diagram illustrating a virtual layout of one example of some components of a storage system according to aspects of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Aspects and embodiments of the present invention provide for a data storage system that directs distribution of data to targeted locations on managed storage media. These target storage locations may be selected by the data storage system using traits of the storage location and the data to be store therein. For example, one aspect of the data storage system uses software and/or hardware to determine, based on user input, the remaining useful life for each storage medium included in the managed storage media. The data storage system may then avoid storing data on any storage medium included in the managed storage media so that the medium may be retired by the end of its remaining useful life without the need for additional data migration.

As discussed further below, according to one embodiment, data is passively and/or actively migrated from media that are closer to retirement to other media having more remaining useful life. This migration may occur as part of the normal operation of a primary or back-up system and thus, the data and the media may remain online during the migration process. Moreover, other embodiments of the system perform this migration without user initiation or intervention. For example, users, such as system administration personnel, may specify policies that define how data is to be stored on data storage equipment. Thereafter the system may notify system administration personnel when human intervention is required. Alternatively, these policies may be configured using a storage media policy configuration application, as is described further below. It is to be appreciated that these policies may include references to various elements of metadata. As used herein, the term “metadata” refers to data that represents information about other system elements, such as user data, system software and/or system hardware, and that describes attributes and/or characteristics of the actual system elements.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

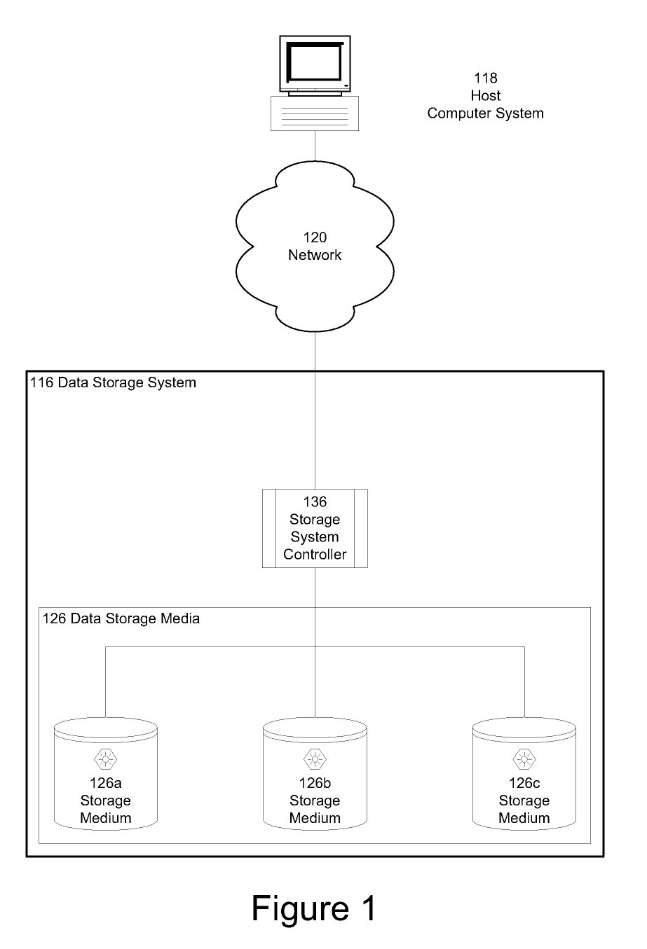

Referring to FIG. 1, there is illustrated in block diagram form, one example of a network computing environment including a data storage system 116 according to aspects of the invention. As illustrated, a host computer 118 is coupled to the data storage system 116 via a network 120. It is to be appreciated that as used herein, the term “host computer” refers to any computing device that has at least one processor. As known to those skilled in the art, processors typically perform a series of instructions resulting in data manipulation. One non-limiting example of a processor is a commercially available processor such as an Intel Pentium, Motorola PowerPC, SGI MIPS, Sun UltraSPARC, or Hewlett-Packard PA-RISC processor, but a host computer may employ any type of processor. Moreover, a host computer may include any sort of computing device such as a mobile computing device (PDA, cell phone, etc. . . . ), a personal computer, a workstation, a mainframe, a networked client, a server, etc. that is capable of communication with other devices, such as a storage system and/or other host computers. Host computers further may include media servers and application servers as well as user computers (which may be user workstations, PCs, mainframes, etc.).

In the environment illustrated in FIG. 1, the host computer 118 issues data exchange requests on behalf of itself, or other networked computers, to the data storage system 116 via the network 120. These data exchange requests cause the data storage system 116 to store and/or retrieve data. For example, host computer 118 may execute a back-up utility that reads data from other host computers connected to network 120 and issues data storage requests to data storage system 116. In another example, host computer 118 can be a general purpose computer running applications that access network data storage, such as, a spreadsheet application or a word processing application. In still another example, other host computers on network 120 may directly provide data exchange requests to the data storage system 116.

The network 120 may be any computing environment in which a plurality of host computers are connected to one or more shared storage systems in such a manner that the storage system(s) can communicate with each of the host computers. Fibre Channel is one example of a communication network that may be used with embodiments of the present invention. A Fibre Channel network may be particularly advantageous as Fibre Channel presently typically outperforms other network technologies when conducting data transfers. However, it is to be appreciated that the networks described herein are not limited to Fibre Channel, and that the various network components may communicate with each other over any network connection, such as Token Ring or Ethernet instead of, or in addition to Fibre Channel, or over combinations of different network connections. Therefore, any reference to Fibre Channel in the following discussion is intended to incorporate other network connections as well. Moreover, aspects of the present invention may also be used in bus topologies, such as SCSI or parallel SCSI.

Still referring to FIG. 1, one embodiment the data storage system 116 includes hardware and software that together provide an interface capable of receiving, processing and responding to data exchange requests. As shown in FIG. 1, the data storage system 116 includes storage media 126 and a storage system controller 136, which is described further below. The storage media 126 may include by any medium capable of storing computer readable data such as, for example, one or more disk arrays. In one embodiment, the storage media 126 include a plurality of ATA or SATA disks. Such disks are “off the shelf” products and may be relatively inexpensive compared to conventional storage array products from manufacturers such as EMC, IBM, etc. The disks making up each array may be of any size, limited only by manufacturing and pricing constraints. The disk arrays may include one or more disk controllers (not shown). Disk controllers may translate disk access protocols, such as, for example, SCSI, to a protocol suitable to the type of disks in the disk array. Thus, disk controllers obviate the need for the storage system controller 136 to be configured with software compatible with multiple disk access protocols. Furthermore, disk controllers may, in accordance with an embodiment, organize the storage media 126 into one of a number of RAID (Redundant Array of Independent Disks) schemes, such as, for example, a RAID-5 scheme.

According to one embodiment, the storage media 126 provide the actual storage space for data from the host computer(s) 118. In one example, the storage media 126 include physical signaling components that indicate a status of the storage media 126 and/or of each individual storage medium 126a, 126b and/or 126c. This status indicator may be used to facilitate management of the storage media, as discussed further below. For example, each storage medium 126a, 126b and/or 126c may include an indicator light that illuminates when the storage medium has reached a state of data content deemed appropriate for decommissioning. The act of decommissioning a storage medium may include removal, refurbishment and/or replacement of the storage medium. In another embodiment, the physical signaling devices can be located separately from the storage media 126 or even located separately from the data storage system 116.

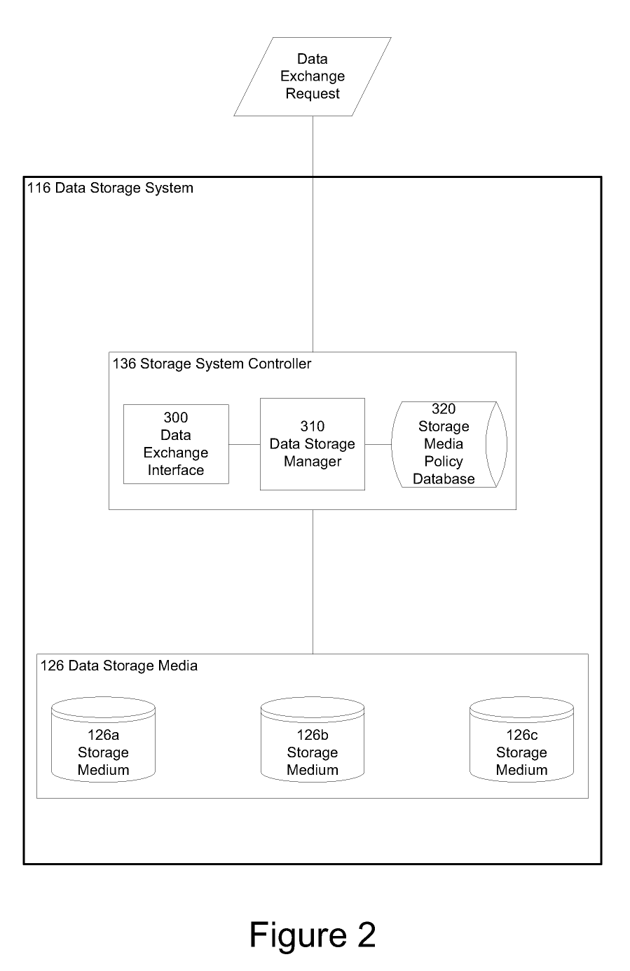

According to one embodiment, the storage system controller 136 includes a processor that is configured by software components to receive, process and respond to data exchange requests. FIG. 2 illustrates examples of these software components, which include a data exchange interface 300, a data storage manager 310 and a storage media policy database 320. It is to be appreciated that the modular structure illustrated in FIG. 2 is exemplary only and is not intended to be limiting. As will be apparent to one of ordinary skill in the art, many variant modular structures are also possible and are within the scope of the present invention. In one example, the storage system controller 136 exposes a data exchange interface 300 to external entities that enable storage and/or retrieval of data with the data storage system 116. The data exchange interface 300 receives, buffers and/or schedules data exchange requests from external entities, and transmits the requests to a data storage manager 310.

Still referring to FIG. 2, the data exchange interface 300 may support various networking and file sharing protocols. For example, in one embodiment, the data exchange interface 300 supports data exchange requests in the form of FTP “gets” and “puts.” In another embodiment, the data exchange interface 300 supports multiple file sharing protocols such as, for example, NFS, CIFS and NCP. While the example illustrated in FIG. 2 includes one data exchange interface 300, it is to be appreciated that multiple data exchange interface instances are also contemplated. Embodiments including the data exchange interface 300 that support a variety of network interface standards may be better positioned for “plug and play” implementation in a heterogeneous network. Alternatively, embodiments including the data exchange interface 300 that supports few or only one network interface may be advantageous in terms of performance and cost.

According to one embodiment, the data storage manager 310 handles allocation and utilization of the storage media 126. For example, with reference to FIG. 2, the data storage manager 310 allocates the storage media 126 into one or more “logical units” (LUNS). A LUN includes a collectively addressable set of storage media, such as a set of disks that provides a storage pool for the data storage system 116. The data storage manager 310 also may utilize the allocated storage capacity to store data included in the data exchange request in accord with certain data migration policies, as discussed further below.

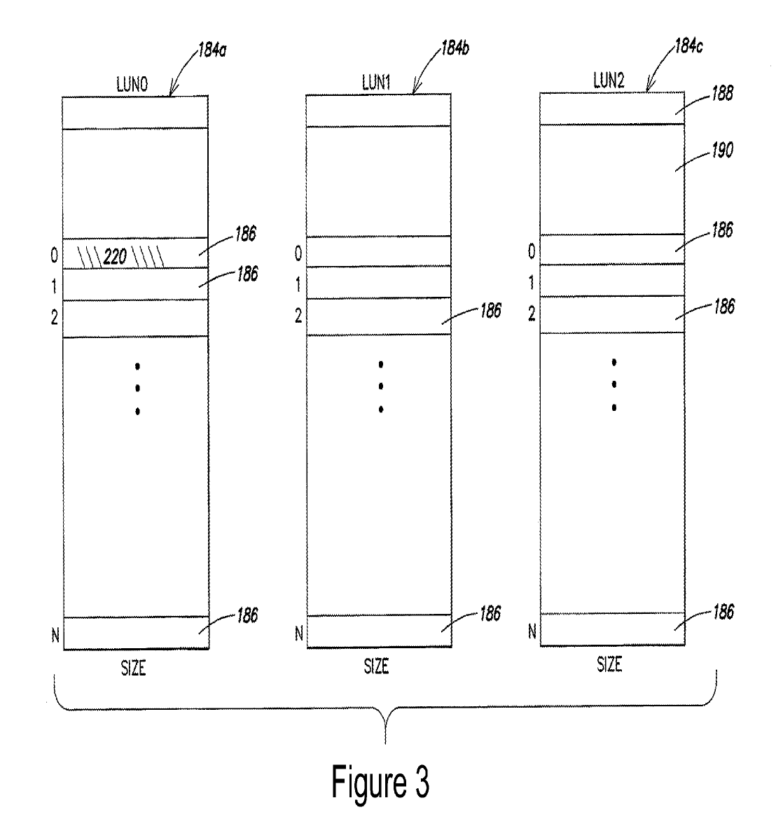

As discussed above, the storage media 126 may include one or more disk arrays including one or more disk controllers. In this case, the data storage manager 310 may instruct the disk controllers included in the disk arrays to divide the disks into the LUNS. The number LUNS in a system, the storage capacity of each LUN and the number of disks making up each LUN may be selected based on cost constraints, the expected volume of data for the data storage system, and/or other factors. In the example illustrated in FIG. 3, the data storage system 116 comprises three LUNS, namely, LUN0 184a, LUN1 184b and LUN2 184c, however it is to be appreciated that the invention is not so limited and any number of LUNS is contemplated.

The storage capacity of each LUN may be tailored to the requirements of each particular installation. For example, in an embodiment where the storage media is responsive to SCSI commands, it may be advantageous to size each LUN 184 to the maximum capacity addressable by SCSI commands, which is presently two Terabytes (TB). In another embodiment, data storage manager 310 may allocate disk space to LUNS on an as needed basis, rather than preallocating LUNS only during system initialization. In this embodiment, therefore, the data storage capacity of the data storage system 116 may be easily augmented after system initialization because the data storage manager 310 will allocate LUNS including new disks without remapping the existing data storage scheme.

Still referring to FIG. 3, in the illustrated example, each LUN 184 is divided into segments 186 referred to herein as “extents.” The data manager 310 may reference many factors when determining how to initially allocate extents. These factors may include, among others, the remaining useful life of the storage media 126, the performance characteristics of the storage media 126, storage capacity of the storage media 126, the characteristics of the data to be stored in the storage media 126, and any applicable media storage policies. For example, when the data storage system 116 is initially commissioned, and the characteristics of the storage media 126 may be relatively homogenous, the initial extent allocation may be performed in a “round robin” fashion, such that a first extent block of data may be stored on LUN0, extent0, a second extent block of data may be stored on LUN1, extent0, a third extent block of data may be stored on LUN2, extent0, a fourth extent block of data may be stored on LUN0, extent1, etc., as illustrated in FIG. 3. In this manner, disk I/O may be spread across the LUNS in the back-up storage system which may be preferable in terms of prolonging disk life, as well as performance.

Over time, the need to decommission storage media may become apparent for a variety of reasons including potential or actual storage medium failure and/or obsolescence. Therefore, in accordance with aspects of the present invention, the data storage manager 310 may migrate data from a storage medium included in the storage media 126 that is targeted for decommissioning to storage medium with more remaining useful life.

Referring again to FIG. 2, in one embodiment, the data storage manager 310 consults one or more storage media policies stored in a storage media policy database 320 when determining how to process a data exchange request. A storage media policy may define the conditions under which data should be migrated from certain storage media and/or to other storage media. Storage media policies may take the form of one or more propositions that are formed from simple elements of information. These propositions may include any assertion that may be evaluated to true or false. For example, in one embodiment, a storage media policy may be stored as one or more logical implications, or “if-then” statements. In this embodiment, the data storage manager 310 evaluates the logical value of the “if” proposition in the context of the data exchange request. If the “if” proposition evaluates to true, the storage media policy is applicable to the data exchange request and any course of action specified by the “then” portion of the statement is performed.

Based on the storage media policies, the data storage manager 310 may evaluate various factors when determining how to distribute data. These factors may include the characteristics of the any storage medium within the storage media 126 and/or the content and/or characteristics of the data stored. Characteristics of the storage medium that may be considered include the remaining capacity of the medium, the remaining useful life of the medium, the amount of historical usage the medium has already endured, and the performance characteristics of the medium. Similarly, characteristics of the data that may be considered include the lifespan of the data, the volume of data, and any software applications that are associated with the data. Time based data, including remaining useful life, may be calculated and stored at any supported level of precision including days, minutes, seconds or fractions thereof. This content-aware and device-aware approach enables users to optimize a data storage system 116 for the particular needs of their installation.

When implemented by the data storage manager 310, storage media policies may result in active or passive migration of data. Active migration of data may include, for example, reading and removing data from an extent that includes storage media targeted for decommissioning and writing that data to another extent. Passive migration of data may include diverting data from storage media targeted for decommissioning and/or distributing the data to other storage media.

In one embodiment, a storage media policy specifies that the data storage manager 310 stop allocating to new extents, any storage medium that has a remaining useful life of less than a certain time period such as, for example, 30 days. The remaining useful life may be entered by a user or may be calculated based on, for example, the commissioning date of the storage medium. Referring to FIG. 2, if a storage medium 126b was placed into service on Jan. 1, 2007 and the useful life of this type of storage medium is projected to be 3 years and 30 days, the data storage manager 310 implementing the above policy would stop allocating new extents using the storage medium 126b on Jan. 1, 2010. Given the configuration of the storage media 126, at that point, the data storage manager 310 would allocate new extents only to storage media 126a and 126c.

Another, similar, example storage media policy may specify that the data storage manager 310 stop allocating to new extents any storage medium that has more than 98% of its storage capacity utilized. Still another example storage media policy may specify that only data with a lifespan of 1 week or less may be stored on extents that include storage media with a useful life of less than 30 days but greater than 14 days. It is to be appreciated that the time spans given herein are examples only, not intended to be limiting, and that similar policies may be created specifying time spans that are selected based on, for example, system, application and/or user requirements. By directing the distribution of data away from storage media targeted for decommissioning, the data storage manager 310 may effectively migrate data to other storage media in a passive, online manner. Thus, this embodiment avoids consuming additional computing resource for data migration and allows other entities to access both the data being migrated and/or the data housed on the storage media that is targeted for decommissioning while the data is being migrated.

As discussed above, storage media policies may also manage data storage based on characteristics of the storage media and/or data, other than the media or data lifespan. For example, a storage media policy may specify that data associated with a specific application should be stored on storage media with a specified average seek time, for example, an average seek time of about 8 ms. In this manner, a storage system that is content-aware (i.e., aware of characteristics of the data) and device-aware (i.e., aware of characteristics of the data storage media) may implement data storage policies that facilitate optimizing data storage within the available data storage media. For example, data that is frequently accessed (such as word processing documents, spreadsheets, database files, etc.) may be stored on those data storage media that have fast access times, whereas data that may be only infrequently used (e.g., automatic back-ups of documents) may be stored on data storage media with slower access times. Such a data storage policy may provide cost and performance benefits by allowing some of the data storage media in a system to be lower performance (and therefore presumably lower cost) without compromising the overall system performance.

According to another embodiment, the data storage manager 310 may also notify users when a storage medium is ready for decommissioning. In general, a storage medium is ready for decommissioning once the state of the data it contains reaches a specific decommissioning target state. In one embodiment, this state is reached when all data has been removed from the data storage medium. In another embodiment, the decommissioning target state may be reached when any data remaining on the data storage medium has expired, i.e., the stored data has no remaining lifespan.

The manner in which the data storage manager 310 notifies users of a storage medium that is ready for decommissioning may vary based on the needs of the installation. For example, data storage manager 310 may cause a storage medium to illuminate a notification light, or beacon, to communicate to users that the storage medium is ready to be removed and/or replaced. In another embodiment, the data storage manager 310 may send an email to a specified user or mailbox. In still another embodiment, the manner in which the data storage manager 310 notifies users can be user configurable.

According to another embodiment, there is provided a method for managing a storage medium to a specified state of data content by a targeted decommissioning date. The targeted decommissioning date may include any point in time, expressed at any supported level of precision. For example, the targeted decommission date may be three years after the date on which the storage medium was first put into service. This method may include passive migration of data from the storage medium by preventing new data storage activities on the storage medium according to a specified storage media policy. By passively migrating data in this fashion, the method may be conducted while both the data and the storage medium remain available for use by internal and external entities.

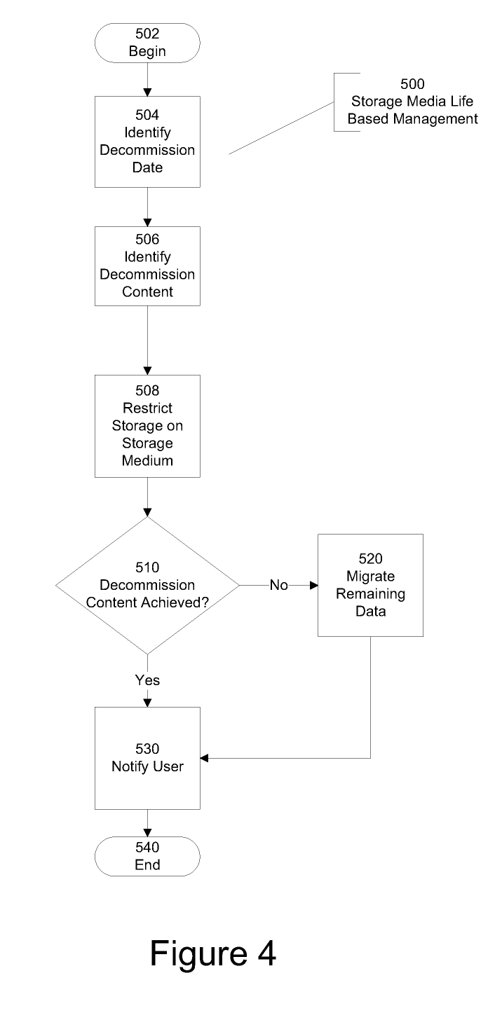

Referring to FIG. 4, there is illustrated a flow diagram of one example of a method of managing a storage medium according to aspects of the invention. At block 502, a process for storage media life based management 500 begins. At block 504, the decommission date of each storage medium is identified. In one embodiment, the decommission date is entered into the system through a user interface. In another embodiment, the decommission date is calculated based on a commissioning date associated with each storage medium. This commissioning date may be entered by a user or may be automatically retrieved from the storage medium through a system interface. The calculation of the decommissioning date may be configured by the user and may factor in the characteristics and utilization of the storage medium. In one embodiment, the calculation may differ depending on the type of storage medium involved. For example, the calculation may set the decommissioning date at three years after the commissioning date for a one type of storage media, while the decommissioning date may be set at two years for a different type of storage media. In another embodiment, the decommissioning date for a particular storage medium may be adjusted by a function of the amount of utilization endured by a storage medium.

At block 506, a specific state of data content is specified as a target to be achieved prior to decommissioning the storage medium. In one embodiment, this state is no data content on the storage medium (i.e., all data content is targeted to be removed from the storage medium by the decommissioning date). In another embodiment, this target state includes either no data content or only expired data residing on the storage medium. In still another embodiment, the target state may allow for live data content that is older than a threshold value or that is associated with a particular application or applications.

Still referring to FIG. 4, at block 508, at a defined point in time prior to the targeted decommission date, data storage activities on the storage medium are restricted. As described above with regard to the data manager 310, the type of restriction may be based on a number of factors including the characteristics of the data to be stored and characteristics of the storage medium. In one embodiment, the restriction is a ban on any new storage activity. In another embodiment, the restriction is a ban on storage of data that meets or does not meet certain criteria defined in an applicable storage media policy. For example, the applicable storage media policy may reference metadata, such as the age of the data, to determine if the data may be stored on a medium that is near the end of its useful life.

At block 510, the state of data content on the storage medium is compared to the decommissioning target state. If the decommissioning target state has been achieved control passes to block 530. If the decommissioning target state has not been achieved control passes to block 520.

At block 520, any data remaining on the storage medium that is preventing the state of data content on the storage medium from achieving the decommissioning target state is migrated from the storage medium to another storage medium using a conventional data migration technique.

At block 530, the system transmits a message communicating the identity of the storage medium that is prepared for decommissioning. As described above the message may be communicated in various forms including, among others, illumination of a beacon and transmission of an email.

At block 540, process 500 ends. Upon completion of process 500, the storage medium is decommissioned by the end of its useful life. This decommissioning is achieved while consuming less system resources than conventional decommissioning techniques involving data migration.

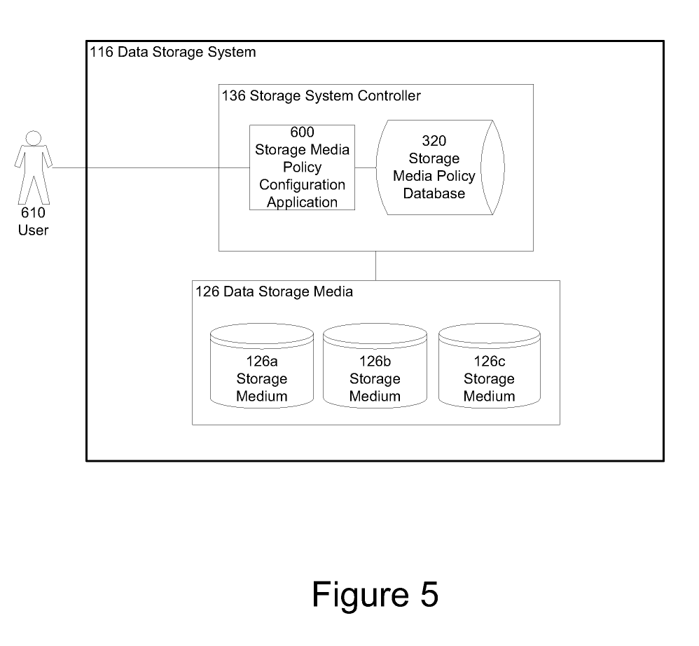

FIG. 5 illustrates, in more detail, the interaction between a user 610 and a storage media policy configuration application 600. In the illustrated embodiment, the user 610 enters storage media policies into the storage media policy database 320 via the storage media policy configuration application 600. The storage media policy configuration application 600 may display various screens to facilitate this data entry. For example, in one embodiment the storage media policy configuration application 600 may display, in one screen, user interface elements to collect an identifier of a storage medium, a commission date and a target decommission date. In this embodiment, the storage media policy configuration application 600 calculates the decommission date as a function of the commission date and/or the type of storage medium identified. The user may then modify this default decommission date and save the modified target decommission date.

In another embodiment, the storage media policy information may be exchanged with other applications or storage media using system interfaces exposed by the storage media policy configuration application 600. Furthermore, to facilitate valid data entry, the storage media policy configuration application 600 may both restrict input to a predefined set of valid values and/or validate any information entered prior to using the information or providing the information to other components.

Thus, aspects and embodiments provide a system and method of data migration and data storage management that can monitor and adapt to changing conditions of the storage media. The system and methods provide controlled usage of storage media assets, including asset life management and risk management. Aspects and embodiments facilitate optimal use of a storage medium during its useful life, while also restricting its use as the end of the useful life approaches, thereby mitigating the risk of data loss. The data storage system manages the storage location of data based on the characteristics of the storage media and of the data being stored, and is thus both content-aware and device-aware. The system uses this awareness to provide efficient and dynamic data storage management, as discussed above.

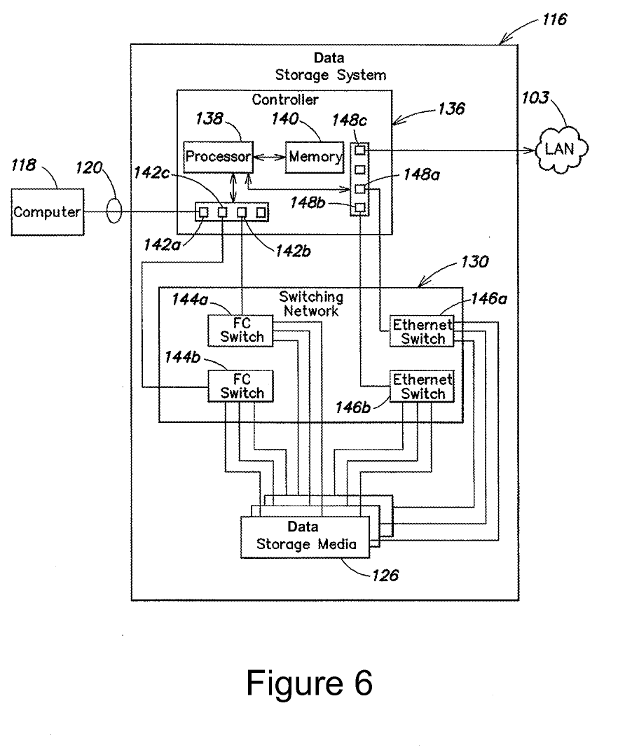

While at least some embodiments of the present invention can be practiced on a conventional, general purpose computing device, more specialized computing devices may also be employed. For example, referring to FIG. 6, there is illustrated in block diagram form, one embodiment of hardware components of the data storage system 116 according to aspects of the invention. In the illustrated embodiment, the hardware of the data storage system 116 includes a storage system controller 136 and the switching network 130 that connects the storage system controller 136 to the storage media 126. The storage system controller 136 includes a processor 138 (which may be a single processor or multiple processors) and a memory 140 (such as RAM, ROM, PROM, EEPROM, Flash memory, etc. or combinations thereof) that runs at least some of the storage system software. The memory 140 may also be used to store metadata relating to the data stored on the storage media 126. Software, including programming code that implements embodiments of the present invention, is generally stored on a computer readable and/or writeable nonvolatile recording medium, such as RAM, ROM, optical or magnetic disk or tape, etc., and then copied into memory 140 wherein it may be executed by the processor 138. Such programming code may be written in any of a plurality of programming languages, for example, Java, Visual Basic, C, C#, or C++, Fortran, Pascal, Eiffel, Basic, COBOL, or combinations thereof, as the present invention is not limited to a particular programming language. Typically, in operation, the processor 138 causes data, such as code that implements embodiments of the present invention, to be read from a nonvolatile recording medium into another form of memory, such as RAM, that allows for faster access to the information by the processor than does the nonvolatile recording medium.

As shown in FIG. 6, the controller 136 also includes a number of port adapters 142a, 142b, 142c that connect the controller 136 to the host computer 118 and to the switching network 130. As illustrated, the host computer 118 is coupled to the storage system via a port adapter 142a, which may be, for example, a Fibre Channel port adapter. Via storage system controller 136, the host computer 118 stores data onto the storage media 126 and can retrieve data from the storage media 126.

Still referring to FIG. 6, in the illustrated example, the switching network 130 includes one or more Fibre Channel switches 144a, 144b. The storage system controller 136 includes a plurality of Fibre Channel port adapters 142b and 142c to couple the storage system controller to the Fibre Channel switches 144a, 144b. Via the Fibre Channel switches 144a, 144b, the storage system controller 136 allows data to be stored onto the storage media 126. As illustrated in FIG. 6, the switching network 130 further includes one or more Ethernet switches 146a, 146b that are coupled to the storage system controller 136 via Ethernet port adapters 148a, 148b. In one example, the storage system controller 136 further includes another Ethernet port adapter 148c that is coupled to a network, for example, a LAN 103, to enable the storage system 116 to communicate with host computers (e.g., user computers).

According to one embodiment, the hardware incorporates redundant components to facilitate reliability and reduce the risk of system failure and/or data loss. Therefore, in the example illustrated in FIG. 6, the storage system controller 136 is coupled to the storage media 126 via a switching network that includes two Fibre Channel switches and two Ethernet switches. Provision of at least two of each type of switch within the storage system 116 eliminates any single points of failure in the system. In other words, even if one switch (for example, Fibre Channel switch 144a) were to fail, the storage system controller 136 would still be able to communicate with the storage media 126 via another switch. Such an arrangement may be advantageous in terms of reliability and speed. For example, as discussed above, reliability is improved through provision of redundant components and elimination of single points of failure. In addition, in another embodiment, the storage system controller is able to store data onto the storage media 126 using some or all of the Fibre Channel switches in parallel, thereby increasing the overall throughput.

However, it is to be appreciated that there is no requirement that the system comprise two or more of each type of switch, or that the switching network comprise both Fibre Channel and Ethernet switches. Furthermore, in examples wherein the storage media 126 comprises a single disk array, no switches at all may be necessary. In one embodiment, the Fibre Channel switches 144a, 144b are used primarily for transferring data between the controller 136 and the storage media 126, and the Ethernet switches 146a, 146b are used primarily for transferring control information between the controller 136 and the storage media 126. In still other embodiments, only a single type of switch, e.g. the Ethernet switches 146a, 146b, may be used for transferring both control information and data. Thus, embodiments of the invention may be practiced using various switch configurations.

It is to be appreciated that the data storage system 116 is not limited to a discrete piece of equipment, although in some embodiments, the data storage system 116 may be embodied as a discrete piece of equipment. Indeed, many functional components in accord with the present invention may be implemented in a combination of software and/or hardware, such as a programmable logic device or ASIC. Thus, it is to be appreciated that there is no requirement that the storage system controller be a contained physical entity such as a computer. However, in at least one example, the data storage system 116 is provided as a self-contained unit that acts as a “plug and play” data storage system. Such a storage system unit may also be used in a networked computing environment that includes a conventional data storage system to provide redundancy or additional storage capacity.

The above-mentioned hardware may be utilized by the various software components disclosed above to support functionality in accordance with embodiments of the present invention. Other commercially available software components may also be included in data storage system 116. Examples of these software components include operating system software, such as Microsoft Windows, Unix, Linux, Solaris, etc., as well as networking, file sharing and hardware device drivers. It is to be appreciated that although the software may be described as being “included” in the data storage system 116, and may be executed by the processor 138 of the storage system controller 136 (see FIG. 6), there is no requirement that all the software be executed on the storage system controller 136. The software programs, such as the storage media policy configuration application, may be executed on any computing device, including the host computers and/or user computers, and portions thereof may be distributed across all or some of the storage system controller, the host computer(s), the user computer(s) or other computing devices. Furthermore, as used herein, the term software is intended to also encompass “firmware,” for example, software embodied in a hardware device such as a ROM, PROM, EPROM, or other programmable device.

Having now described some illustrative aspects of the invention, it should be apparent to those skilled in the art that the foregoing is merely illustrative and not limiting, having been presented by way of example only. While the bulk of this disclosure is focused on embodiments include hard disks and hard disk arrays, aspects of the present invention may be applied to other computer readable media, for example, tape and optical media. Similarly, aspects of the present invention may be used to achieve other objectives including enabling system administrators to project future data storage capacity with greater accuracy. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A method for distributing data on a plurality of computer readable data storage media, the method comprising:
identifying a decommission date of a first data storage medium of the plurality of computer readable data storage media; and
configuring a controller to restrict storage of the data on the first data storage medium as of a restriction date that is prior to the decommission date.

2. The method according to claim 1, wherein identifying the decommission date comprises identifying the decommission date based at least in part on a commissioning date of the first data storage medium.

3. The method according to claim 1, wherein configuring the controller to restrict storage comprises configuring the controller to cease allocation of unused storage capacity on the first data storage medium.

4. The method according to claim 1, wherein configuring the controller to restrict storage comprises configuring the controller to prohibit storage of the data on the first data storage medium.

5. The method according to claim 1, wherein configuring the controller to restrict storage comprises configuring the controller to redirect the data from the first data storage medium to a second data storage medium of the plurality of computer readable data storage media.

6. The method according to claim 1, further comprising defining the restriction date based at least in part on the decommission date.

7. The method according to claim 1, further comprising adjusting the decommission date based at least in part on past utilization of the first data storage medium.

8. The method according to claim 1, further comprising adjusting the decommission date based at least in part on anomalous operation of the first data storage medium.

9. The method according to claim 1, further comprising copying stored data from the first data storage medium to a second data storage medium of the plurality of computer readable data storage media.

10. The method according to claim 1, further comprising defining a targeted state of data content for the first data storage medium to be reached by the decommission date, and wherein determining the restriction date includes determining the restriction date based at least in part on the decommission date and the targeted state of data content.

11. The method according to claim 10, wherein defining the targeted state of data content comprises defining the targeted state of data content based at least in part on metadata describing the data associated with the first data storage medium.

12. The method according to claim 11, wherein defining the targeted state of data content based at least in part on metadata comprises defining the targeted state of data content based at least in part on an expected lifespan of the data associated with the first data storage medium.

13. The method according to claim 11, wherein defining the targeted state of data content based at least in part on metadata comprises defining the targeted state of data content based at least in part on an association of a software application with the data associated with the first data storage medium.

14. The method according to claim 1, further comprising notifying a user that the first data storage medium is ready to be decommissioned.

15. The method according to claim 14, wherein notifying the user comprises transmitting an electronic notification.

16. The method according to claim 14, wherein notifying the user comprises illuminating a beacon.

17. A computer readable medium comprising computer readable instructions that, as a result of being executed by a processor, instruct the processor to perform a method, the method comprising:
identifying a decommission date of a first data storage medium of the plurality of computer readable data storage media; and
configuring a controller to restrict storage of the data on the first data storage medium as of a restriction date that is prior to the decommission date.

18. A system for storing data comprising:
a first storage medium;
an interface configured to receive data to be stored; and
a controller coupled to the first storage medium and to the interface and configured to restrict storage of the data on the first data storage medium based at least in part on a decommission date for the first data storage medium.

19. The system according to claim 18, further comprising:
a second storage medium; and
wherein the processor is further configured to store the data on the second storage medium.

20. The system according to claim 18, further comprising:
a physical notification device coupled to the first data storage medium, the physical notification device indicating when the first data storage medium is ready to be decommissioned.

21. The system according to claim 18, wherein the processor is further configured to adjust the decommission date based at least in part on utilization data associated with the first storage medium.

22. A method of storing data in a system comprising multiple data storage devices, the method comprising:
storing data on the multiple data storage devices; and
identifying a decommission date on which a first data storage device is to be decommissioned;
wherein, as of a restriction date that is prior to the decommission date, storing the data includes distributing the data across any of the multiple data storage devices other than the first data storage device.

23. A method of storing data in a backup data storage system that includes a plurality of data storage devices, the method comprising:
reading metadata describing the plurality of data storage devices, the metadata indicating a decommission date of a first data storage device of the plurality of data storage devices; and
restricting storage of the data on the first data storage device of the plurality of data storage devices based at least in part on the metadata.

24. The method according to claim 23, wherein restricting storage comprises restricting storage of the data on the first data storage device of the plurality of data storage devices based at least in part on a predetermined attribute of the first data storage device of the plurality of data storage devices.

25. The method according to claim 24, wherein restricting storage of the data on the first data storage device of the plurality of data storage devices based at least in part on the predetermined attribute comprises restricting storage of the data on the first data storage device of the plurality of data storage devices based at least in part on a decommission date being within a predetermined proximity to the current date.

26. The method according to claim 23, further comprising defining a restriction date based at least in part on the metadata and wherein restricting storage comprises restricting storage of the data on the first data storage device of the plurality of data storage devices based at least in part on the restriction date.
